(19) United States
(12) Patent Application Publication
(10) Pub. No.: US 2024/0068497 A1
(43) Pub. Date: Feb. 29, 2024

(54) MECHANICALLY ATTACHED EDGE SYSTEM FOR TWO OR MORE WORK PIECES

(71) Applicant: De Lorenzo Marble & Tile, Inc., Torrance, CA (US)

(72) Inventor: Joseph De Lorenzo, Torrance, CA (US)

(21) Appl. No.: 18/455,801

(22) Filed: Aug. 25, 2023

Related U.S. Application Data
(60) Provisional application No. 63/373,943, filed on Aug. 30, 2022.

(51) Int. Cl. F16B 5/06

(52) U.S. Cl. CPC F16B 5/0614

(57) ABSTRACT

An edge system for joining a first decorative body with a second decorative body includes an inner support body having a first support flange positionable adjacent the first decorative body and a second support flange positionable adjacent the second decorative body. An attachment truss extends between the first and second support flanges. The edge system additionally includes an outer body having an internal channel formed therein, with the outer body being configured to be placeable between the first decorative body and the second decorative body. The edge system further comprises a fastener having a head portion and a shaft portion, with the head portion being translatably receivable within the internal channel of the outer body. The shaft portion is sized to extend from the head portion to the inner support body to facilitate connection between the outer body and the inner support body.

### CROSS-REFERENCE TO RELATED APPLICATIONS

This application claims the benefit of U.S. Provisional Application No. 63/373,943, filed Aug. 30, 2022, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to an edge system, and more specifically, to a mechanically attached edge system for joining two or more work pieces, such as two or more decorative bodies.

### 2. Description of the Related Art

It is well known to attach decorative bodies, such as tiles, slabs or other decorative work pieces to a floor or wall to create a desired aesthetic appearance. The decorative bodies may come in a variety of shapes, colors, patterns, sizes, etc., to appeal to a variety of different aesthetic preferences. The decorative bodies are typically installed on an underlying substrate, e.g., the floor or wall, using a mortar between the decorative body and the substrate to firmly secure the decorative body to the substrate. The decorative bodies may be slightly spaced from each other by a prescribed distance, with the space being filed by grout once the decorative bodies have been set to create a finished look.

Conventional tiling/attaching techniques, such as those described above, are associated with several deficiencies. One particular deficiency is the requirement that the decorative body be mounted on an underlying substrate. This particular limitation constrains the types of shapes and structures with which the decorative bodies may be associated.

Another limitation commonly associated with conventional tiling techniques is the frequent use of grout. Although grout may be desired in some instances, there may be particular aesthetics in which grout may not be desired.

Accordingly, there is a need in the art for a decorative body system and associated methodology that does not require an underlying substrate or the use of grout. Various aspects of the present disclosure address this particular need, as will be discussed in more detail below.

### BRIEF SUMMARY

The present disclosure is directed toward an edge system for joining a first decorative body with a second decorative body. The edge system includes an inner support body having a first support flange positionable adjacent an inner surface of the first decorative body and a second support flange positionable adjacent an inner surface of the second decorative body. The second support flange and the first support flange define an angle therebetween. An attachment truss extends between the first support flange and the second support flange. The edge system additionally includes an outer body having an internal channel formed therein, with the outer body being configured to be placeable between the first decorative body and the second decorative body. The edge system further comprises a fastener having a head portion and a shaft portion, with the head portion being translatably receivable within the internal channel of the outer body. The shaft portion is sized to extend from the head portion to the inner support body to facilitate connection between the outer body and the inner support body.

The first support flange and the second support flange define an angle therebetween equal to 90 degrees.

The inner support may include a bore extending therethrough adjacent an intersection of the first support flange and the second support flange.

The attachment truss may include an opening, with the shaft portion of the fastener being sized to be receivable within the opening in the attachment truss.

The outer body may include an exposed plate having a finished outer surface. The outer body further includes a first attachment arm and a second attachment arm, with the first attachment arm and the second attachment arm both extending from the exposed plate in spaced relation to each other. The exposed plate, the first attachment arm, and the second attachment arm may collectively define the internal channel. The first attachment arm and the second attachment arm may both include respective distal portions spaced from each other to define a gap therebetween, with the gap being sized to allow for passage of the shaft portion therethrough.

The inner support body may be configured to be selectively moveable along the shaft portion to facilitate application of a compressive force on the first decorative body and the second decorative body between the inner support body and the outer body.

According to another embodiment, the edge system includes an inner support body configured to include a first portion positionable adjacent an inner surface of the first decorative body and a second portion positionable adjacent an inner surface of the second decorative body. The edge system additionally includes an outer body having an internal channel formed therein, the outer body being configured to be placeable between the first decorative body and the second decorative body. The edge system further comprises a fastener having a head portion and a shaft portion. The head portion is translatably receivable within the internal channel of the outer body, and the shaft portion is sized to extend from the head portion to the inner support body to facilitate connection between the outer body and the inner support body.

The inner support body may be configured to be selectively moveable along the shaft portion to facilitate application of a compressive force on the first decorative body and the second decorative body between the inner support body and the outer body.

According to another embodiment, there is provided a setting device for setting a position of a first decorative body relative to a second decorative body. The setting device includes an inner setting bracket having a first engagement portion and a second engagement portion extending at a prescribed angle relative to the first engagement portion. The first and second engagement portions are positionable adjacent the first and second decorative bodies, respectively. An outer spacing body includes a first lateral engagement portion, a second lateral engagement portion, and a middle engagement portion. The first and second lateral engagement portions are positionable adjacent the first and second decorative bodies, respectively, in spaced relation to the inner setting bracket. The middle engagement portion is positioned between the first and second lateral engagement portions and being configured to engageable to both the first and second decorative bodies. A shaft extends between the inner setting bracket and the outer spacing body. An adjuster is moveable along the shaft to facilitate positional adjustment of the outer setting body relative to the inner setting bracket.

The adjuster may include a hub, a spoke, and an outer rim, with the spoke extending between the hub and the outer rim. The hub is threadingly engageable to the shaft, such that rotation of the hub relative to the shaft in a first rotational direction causes translation of the hub along the shaft in a first axial direction, and rotation of the hub relative to the shaft in a second rotational direction causes translation of the hub along the shaft in a second axial direction.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an end view of an edge system joining two decorative bodies together;

FIG. 2 is an end view of an outer body of the edge system;

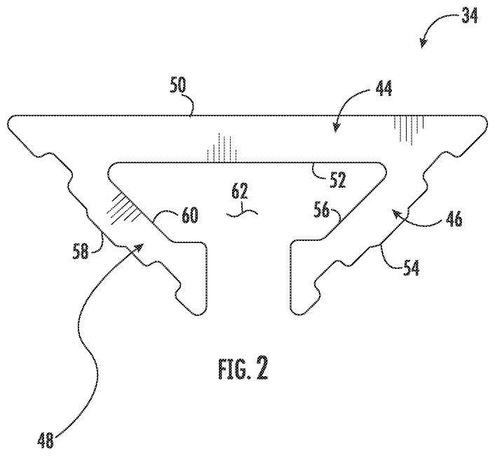

FIG. 3 is a front upper perspective view of an embodiment of the edge system used to join two decorative bodies together;

FIG. 4 is a rear upper perspective view of the edge system and decorative bodies of FIG. 3;

FIG. 5 is a front upper perspective view of the edge system and decorative bodies of FIG. 3 taken from a different angle;

FIG. 6 is a top view of the edge system and decorative bodies depicted in FIGS. 3-5;

FIG. 7 is a rear upper perspective view of an embodiment of the edge system used to join several pieces of decorative body together;

FIG. 8 is an end view of an embodiment of the edge system used to join several pieces of decorative body together;

FIG. 9 is an upper perspective view of a cuboid structure formed from decorative body and an embodiment of the edge system;

FIG. 10 is an enlarged upper perspective view of the cuboid structure of FIG. 9, highlighting an intersection of multiple outer bodies of the edge system;

FIG. 11 is an enlarged upper perspective view of the cuboid structure of FIG. 10, taken from a different angle;

FIG. 12 is an upper perspective view of a setting system used to set a position of a first decorative body relative to a second decorative body in preparation for attachment of the edge system thereto; and

FIG. 13 is a side, cross sectional view of the setting system depicted in FIG. 12.

Common reference numerals are used throughout the drawings and the detailed description to indicate the same elements.

### DETAILED DESCRIPTION

The detailed description set forth below in connection with the appended drawings is intended as a description of certain embodiments of an edge system and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating preferred embodiments of the present disclosure only and are not for purposes of limiting the same, there is depicted an edge system for use in joining together two decorative bodies or other work pieces. The edge system may include an outer body that is connectable to an inner support body via a selectively positionable and adjustable fastener. The outer body may include an exposed surface that may be positionable adjacent an exposed surface of the decorative bodies in a manner which creates a smooth, seamless appearance. In this regard, the edge system may be used to connect the decorative bodies without mortar, grout, or other conventional gap-filling substances. Indeed, the tight, clean connection facilitated by the edge system may eliminate any noticeable gaps between the decorative bodies and the outer body. Furthermore, the configuration of the edge system allows for mechanical attachment of the decorative bodies without the need for an underlying substrate or support surface. As such, the decorative bodies may be used to form a free-standing object or structure.

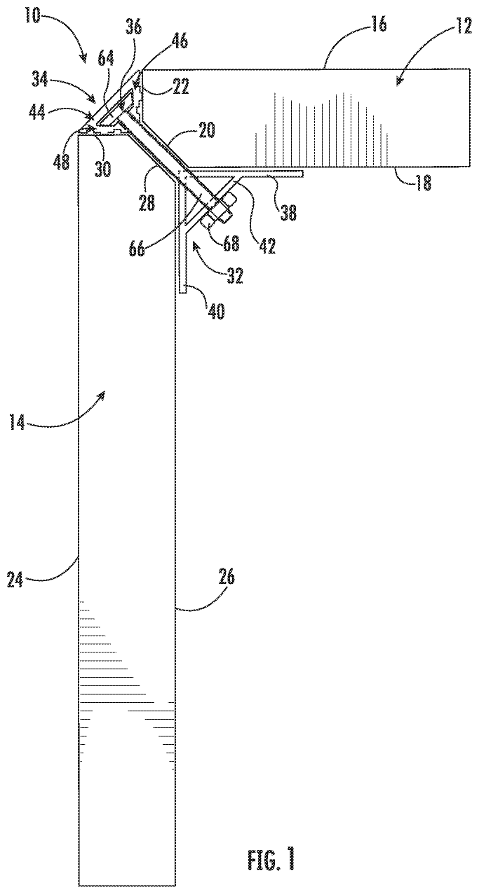

Referring now specifically to FIG. 1, there is depicted edge system 10 configured to connect a first decorative body 12 to a second decorative body 14. Before discussing the particulars of the edge system 10, the features and attributes of the decorative bodies 12, 14 will first be discussed. In the exemplary embodiment, the first decorative body 12 includes an outer surface 16, an opposing inner surface 18, and a first joint surface having an inner segment 20 and an outer segment 22. The second decorative body 14 is similarly constructed, and includes an outer surface 24, an opposing inner surface 26, and a second joint surface having an inner segment 28 and an outer segment 30. The inner and outer segments 20, 22, 28, 30 of the first and second decorative bodies 12, 14 may be configured to form a quirk-miter joint. In this regard, the outer segments 22, 30 may define a generally right-angle relative to the corresponding outer surface 16, 24. Furthermore, the outer segments 22, 30, and the inner segments 20, 28 may extend at an approximate 135-degree angle relative to each other. When the decorative bodies 12, 14 are joined using the edge system 10 described herein, the inner segments 20, 28 may be generally parallel to each other, while the outer segments 22, 30 may be at generally right angles relative to each other. Although the decorative bodies 12 ,14 depicted in FIG. 1 are configured with a quirk-miter joint, it is contemplated that the use of the edge system 10 is not limited to decorative bodies 12, 14 being so configured. For instance, the first and second joint surfaces may include at least some segment or portion that is complementary in shape to that of a portion of the edge system 10 (e.g., the outer body, as will be discussed in more detail below). In this regard, decorative bodies 12, 14 that have other configurations, and in particular, different edging configurations, may be used without departing from the spirit and scope of the present disclosure.

The decorative bodies 12, 14 may be formed from a variety of different materials, such as ceramic, glass, porcelain, marble, granite, other natural stone, wood, etc. In this regard, the term decorative body as used herein refers broadly to tiles, slabs, panels, or other work pieces or construction materials known in the art.

With the features of the decorative bodies 12, 14 having been described, the particulars of the edge system 10 will now be discussed. The edge system 10 generally includes an inner support body 32, an outer body 34, and a fastener 36 for connecting the outer body 34 to the inner support body 32. According to one embodiment, the inner support body 32 includes a first support flange 38, a second support flange 40, and an attachment truss 42 extending between the first support flange 38 and the second support flange 40. The first support flange 38 is configured to be positionable adjacent the inner surface 18 of the first decorative body 12, while the second support flange 40 is configured to be positionable adjacent the inner surface 26 of the second decorative body 14. An adhesive or other bonding material or agent may be used to secure the first and second decorative bodies 12, 14 to the first and second support flanges 38, 40.

The first and second support flanges 38, 40 may be positioned relative to each other to define a prescribed angle therebetween. Given the placement of the first and second decorative bodies 12, 14 adjacent the first and second support flanges 38, 40, the angle defined between the first and second support flanges 38, 40 also corresponds to, or defines, the angle between the first and second decorative bodies 12, 14 (e.g., the angle between the outer surface 16 of the first decorative body 12 relative to the outer surface 24 of the second decorative body 14). In the exemplary embodiment, the first and second support flanges 38, 40 are positioned so as to define an angle of approximately 90 degrees therebetween. As such, the angle between the first decorative body 12 and the second decorative body 14 is also approximately 90 degrees. However, other embodiments of the inner support body 32 may include first and second flanges 38, 40 positioned relative to each other to define an angle having a magnitude that may be different than 90 degrees. In this regard, the angle may vary from zero degrees to almost 360 degrees (e.g., 359 degrees).

The attachment truss 42 may extend between the first and second flanges 38, 40 at a location spaced from the junction of the first and second flanges 38, 40. The attachment truss 42 may provide structural support to the first and second flanges 38, 40 to maintain the desired angle therebetween. In the exemplary embodiment, the attachment truss 42 intersects the first and second flanges 38, 40 at an approximate midpoint between the intersection of the first and second flanges 38, 40, and the terminal ends of the first and second flanges 38, 40, although the position of the attachment truss 42 is not limited thereto. In this regard, the configuration of the first and second flanges 38, 40 and the attachment truss 42 may generally form an “A” shape.

Although the exemplary embodiment of the inner support body 32 is such that the first and second flanges 38, 40 extend beyond the attachment truss 42, it is contemplated that other embodiments of the inner support body 32 may have a different configuration. In particular, the first and second flanges 38, 40 may terminate at the attachment truss 42, or stated differently, the attachment truss 42 may be located at the distal ends of the first and second flanges 38, 40. In this regard, the inner support body 32 may be of a generally triangular cross sectional configuration.

Although the attachment truss 42 is shown in the exemplary embodiment, it is contemplated that other embodiments of the inner support body 32 may be formed without an attachment truss 42. In such an embodiment, the inner support body 32 may be formed solely from the first and second flanges 38, 40.

The inner support body 32 may additionally include a bore passing through the attachment truss 42 and the first and/or second flanges 38, 40 to accommodate the fastener 36. In the exemplary embodiment, the bore passes through the intersection of the first and second flanges 38, 40.

The inner support body 32 may be formed from metal, polymers, composites or other materials known in the art. In this regard, the inner support body 32 may have an inherent strength capable of supporting the weight of the first and second decorative bodies 12, 14. The first and second support flanges 38, 40 may be integral to each other or formed as a unitary body. Alternatively, the first and second support flanges 38, 40 may be welded, adhered, or otherwise secured to each other. Similarly, the attachment flange 42 may also be welded, adhered or otherwise secured to the first and second support flanges 38, 40.

The inner support body 32 is attachable to the outer body 34, which is configured to provide an aesthetically appealing exposed surface, as well as being configured to be attached or abutted against the first and second decorative bodies 12, 14. In this regard, the outer body 34 may include an exposed plate 44, a first attachment arm 46, and a second attachment arm 48. The exposed plate 44 includes an outer surface 50 and an opposing inner surface 52. The outer surface 50 of the exposed plate 44 may be finished (e.g., polished, brushed, etched, carved, etc.) to achieve a desired aesthetic look. The first attachment arm 46 includes a first outer surface 54 and a first inner surface 56, and the second attachment arm 48 includes a second outer surface 58 and a second inner surface 60. Each of the first and second attachment arms 46, 48 may extend away from the exposed plate 44 and terminate at a distal end. The distal ends may be spaced from each other to provide a gap that may be aligned with the bore to accommodate the fastener 36, as will be described in more detail below.

The first and second outer surfaces 54, 58 of the first and second attachment arms 46, 48 may be configured to facilitate attachment to the first and second decorative bodies 12, 14, respectively. In one particular embodiment, each of the first and second outer surfaces 54, 58 may include one or more grooves or channels extending longitudinally to create space for an adhesive which may be used to secure the outer body 44 to the first and second decorative bodies 12, 14.

The outer body 34 may additionally include an internal channel 62 extending longitudinally along a length of the outer body 34. In this regard, the internal channel 62 may extend between opposing end surfaces of the outer body 34. In one embodiment, the internal channel 62 is collectively defined by the inner surfaces 52, 56, 60 of the exposed plate 44, the first arm 46, and the second arm 48.

The outer body 34 may be an extruded body formed from metal, plastic, a polymer or the like. In this regard, the outer body 34 may define a consistent or uniform transverse cross section along the entire length thereof. The outer body 34 may be formed in long lengths that may be cut to size depending on the particular needs of a given installation. Although extrusion may be a preferred fabrication technique, it is contemplated that other fabrication techniques may also be used without departing from the spirit and scope of the present disclosure.

As noted above, the edge system 10 additionally includes fastener 36 which may be used to connect the outer body 34 to the inner support body 32. According to one embodiment, the fastener 36 may include a head portion 64 and a shaft portion 66. The head portion 64 may be sized and configured to be translatably receivable within the internal channel 62 of the outer body 34. The ability of the head portion 64 to translate along the length of the internal channel 62 may allow for selective positioning of the fastener 36 relative to the outer body 34.

The shaft portion 66 may be sized to extend from the head portion 64 to the inner support body 32 to facilitate connection between the outer body 34 and the inner support body 32. In more detail, the shaft portion 66 may be configured to extend through the gap defined by distal ends of the first and second attachment arms 46, 48, between the inner segments 20, 28 of the first and second joint surfaces, and then through the bore of the inner support body 32, such that a portion of the shaft portion 66 extends through the attachment truss 42. The shaft portion 66 may be externally threaded, and may be configured to engage with an internally threaded nut 68 or other connecting element. The tightening of the nut 68 on the shaft portion 66 draws the nut 68 toward the head portion 64, and thus, urges the inner support body 32 toward the outer body 34, thereby tightening the engagement with the decorative bodies 12, 14. Thus, by selectively tightening or loosening the nut 68 on the shaft portion 66, a user may selectively adjust the degree to which the overall system 10 is tight or loose. In many implementations, it may be desirable for the overall system 10 to be tight to minimize any visual gaps, as well as to enhance the overall structural integrity of the system 10. However, there may be certain implementations of the edge system 10, particularly outdoor installations, wherein a desired degree of play/movement between the decorative bodies and the edge system 10 may be desired to accommodate thermal expansion and contraction. The ability to adjust the tightness of the system 10 may also be useful when used with decorative bodies 12, 14 having surface variation.

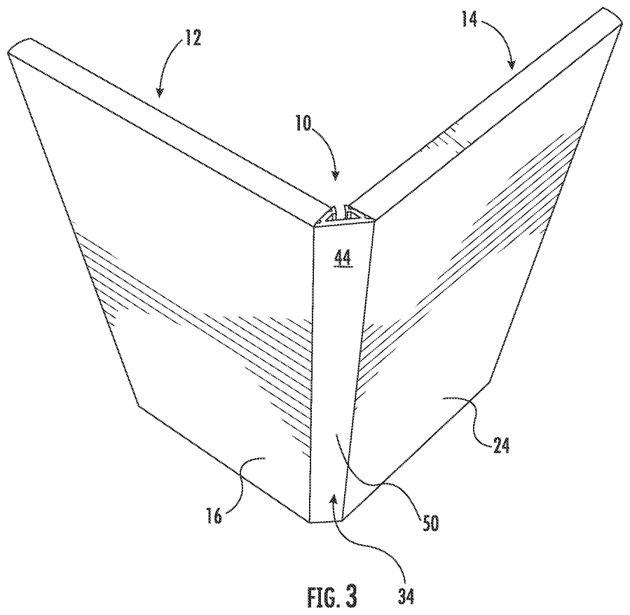

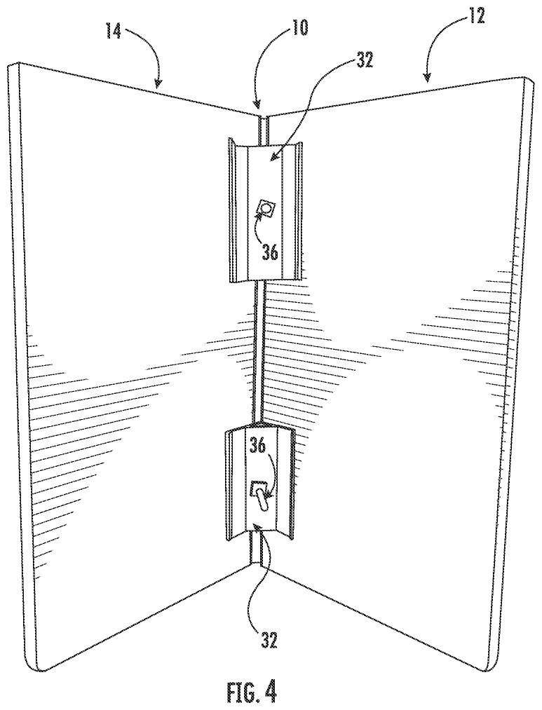

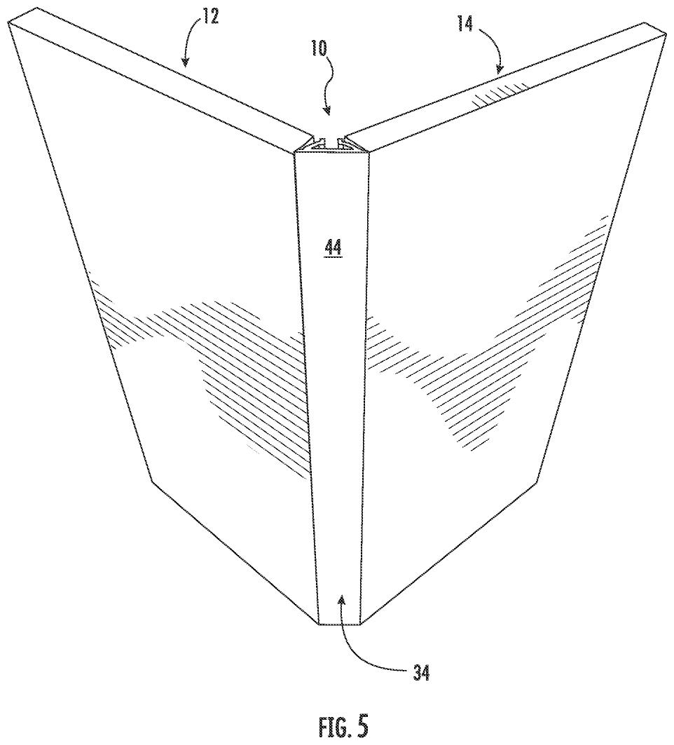

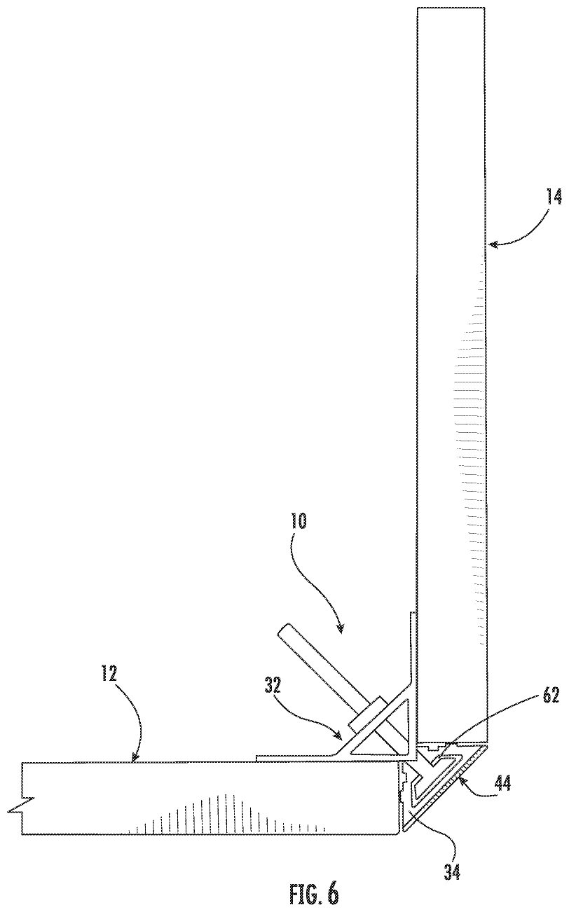

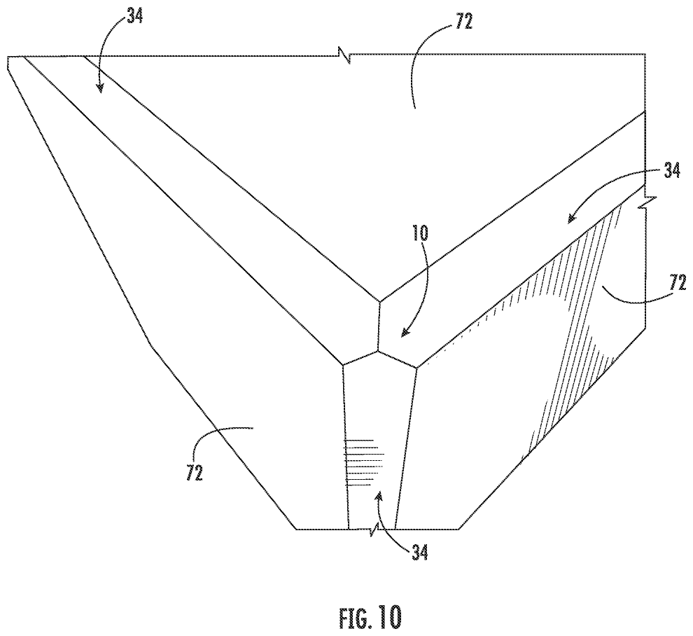

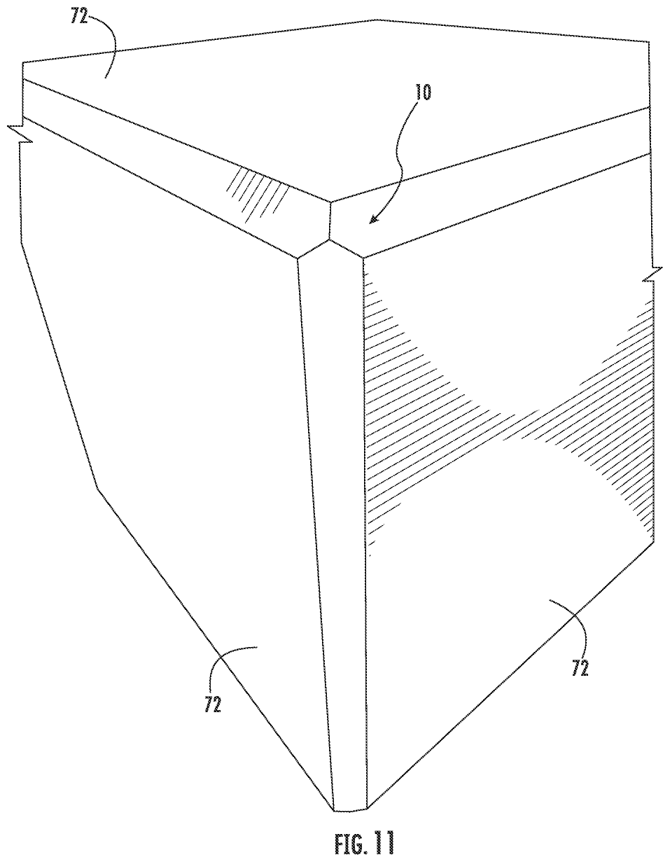

With the basic structure of the edge system 10 having been described above, and referring now specifically to FIGS. 3-11, various implementations of the edge system 10 will now be described. A first implementation is depicted in FIGS. 3-6, which include various views of edge system 10 used to connect two decorative bodies 12, 14 together. As can be seen in FIGS. 3 and 5, the outer surface 50 of the outer body 34 mates flush with the outer surfaces 16, 24 of the decorative bodies 12, 14 to create a clean, seamless look. FIG. 4 shows a rear view of the edge system 10 and decorative bodies 12, 14. In particular, two inner support bodies 32 and two corresponding fasteners 36 are used to secure the decorative bodies 12, 14 together. The configuration of the outer body 34 with the continuous internal channel 62 may allow for use of a plurality of fasteners 36 and inner support bodies 32 with a single outer body. Furthermore, the fasteners 36 and inner support bodies 32 may be selectively positioned relative to the outer body 34 and the decorative bodies 12, 14 as desired. The rear view in FIG. 4 also illustrates the ability to secure the decorative bodies 12, 14 to each other independent of an underlying substrate. Rather, the decorative bodies 12, 14 may form a freestanding structure when connected using the edge system 10.

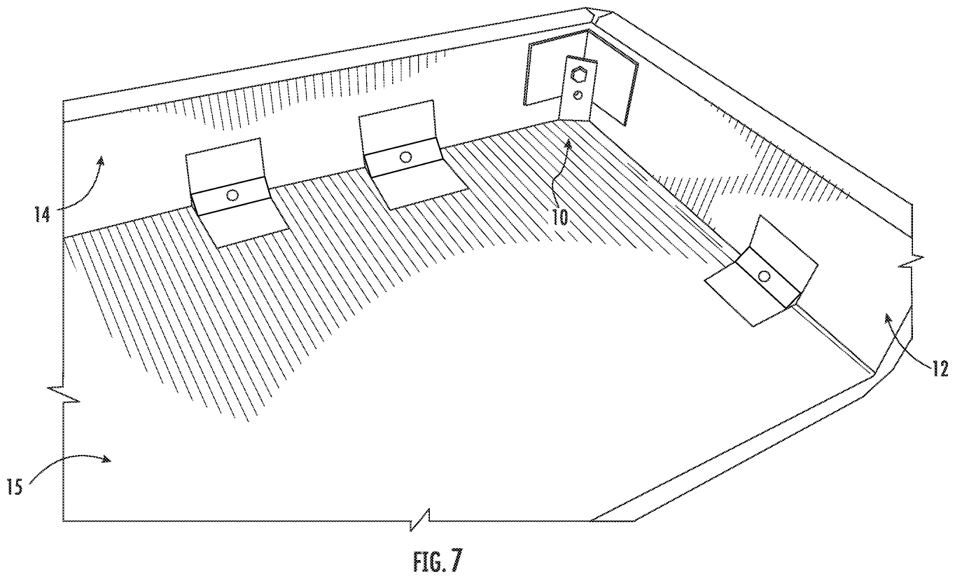

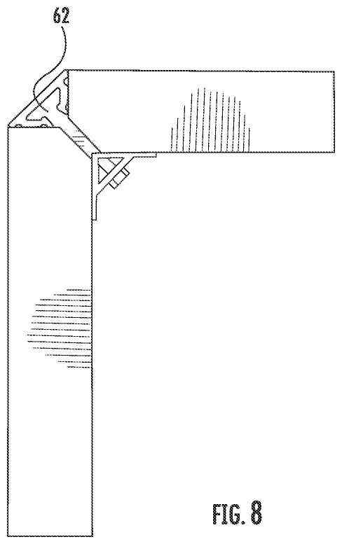

FIGS. 7 and 8 depict another implementation of the edge system 10 used to join several decorative bodies 12, 14, 15 together. In particular, the edge system 10 allows for joining a first decorative body 12 to a second decorative body 14 and a third decorative body 15, with the second 14 and third decorative bodies 15 being generally perpendicular to the first decorative body 12. This particular implementation may be particularly desirable for countertops, desks, shelves, etc. FIG. 8 also illustrates the internal channel 62 having been filled with a material, which may be useful to enhance the structural integrity of the overall assembly, fill openings to prevent snags, cuts, etc., or to achieve a desired look.

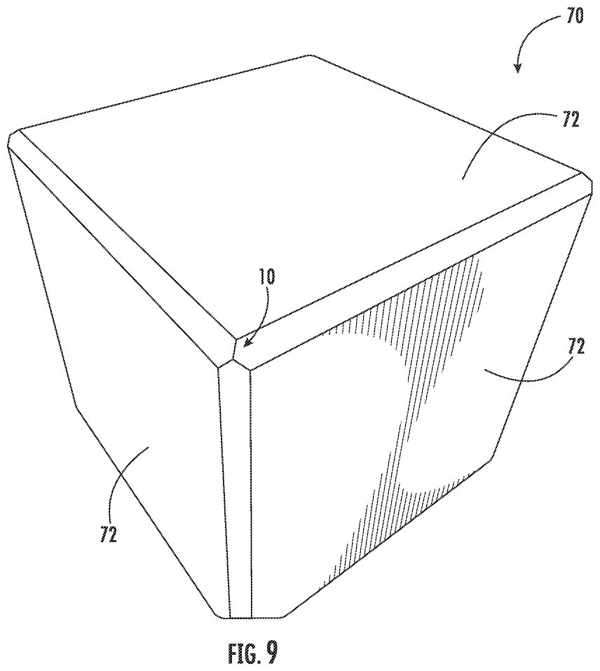

FIGS. 9-11 illustrate a three-dimensional cuboid structure 70 that is formed from a plurality of decorative bodies 72 held together by another implementation of the edge system 10. The cuboid structure 70 may be hollow, e.g., devoid of an underlying support substrate. The outer appearance of the cuboid structure 70 is defined by the decorative bodies 72, as well as the outer bodies 34, which may be configured to intersect with each other in a clean, cooperatively interfacing manner.

The configuration of the edge system 10 may minimize chipping on brittle stone or slab materials. The edge system 10 may also allow for installation of decorative body without grout (e.g., grout-less), and instead, may incorporate metal edging.

It is contemplated that any dimension mentioned herein or the associated drawings is given as an example, and is not intended to limit the scope of the present disclosure. Along these lines, any dimension may be associated with a tolerance acceptable in the trade, such as +/−5%.

In addition to the foregoing, there are various accessories that may be used in connection with the edge system, or modifications that may be made to the edge system, without departing from the spirit and scope of the present disclosure. Appended hereto are several drawings and images which depict exemplary accessories and modifications. For instance, the edge system may include a wood veneer that may be secured to the outer body. In this regard, the veneer may cover the outer body to provide a desired aesthetic look.

Another modification may relate to the type of fastener used to secure the outer body to the inner support body. One alternative fastener may include a zip-tie fastener. Another alternative fastener may include a rivet that may be fastened from the outside, with the head of the rivet being set within an inset bevel formed in the outer body. Yet another exemplary fastener may include a mechanical fastening element which, in one sense, may be a combination of the outer body and the fastener shaft. In particular, the head of such fastener may be similar to the outer body and may be integrally connected to a shaft which extends between the decorative bodies. The shaft may have a threaded portion, which engages with an inner support body, such that as the inner support body is a threaded engagement with the shaft, the distance between the fastener head and the inner support body may decrease to clamp onto the decorative bodies.

In addition, the profile and material of the outer body, which may be extruded, may take on a variety of different shapes and configurations. For instance, the outer body may have a generally concave shaped outer surface.

It is also contemplated that the outer body may be bent to extend along a corner.

Yet another variation may relate to the material used in forming the outer body. Indeed, the outer body may be formed from a wide variety of materials, including wood and wood laminate.

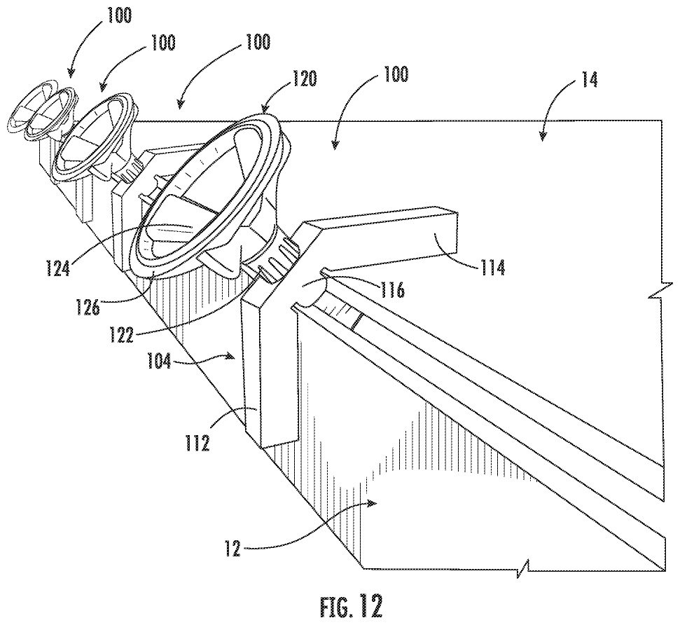

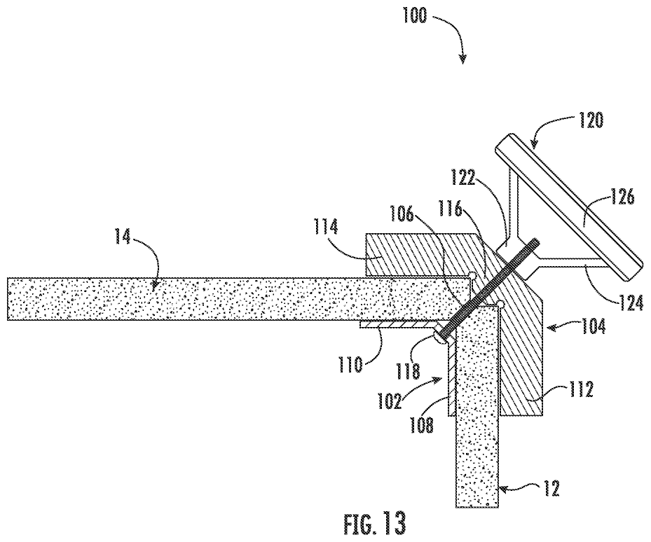

Referring now to FIGS. 12 and 13, there is depicted a setting device 100 specifically configured and adapted for use in setting the position of the decorative bodies 12, 14 prior to installation of the edge system 10. In this regard, the setting device 100 may create the desired spacing and angular orientation of the adjacent decorative bodies 12, 14 to create an easy and relatively seamless attachment of the edge system 10 to the decorative bodies 12, 14.

According to one embodiment, the setting device 100 includes an inner setting bracket 102 configured to interface with the inner surfaces of the decorative bodies 12, 14 and an outer spacing body 104 configured to interface with an outer surface of the decorative bodies 12, 14. A shaft 106 extends between the inner setting bracket 102 and the outer spacing body 104 to connect the inner setting bracket 102 to the outer spacing body 104.

The inner setting bracket 102 includes a first engagement portion (e.g., first engagement flange) 108 and a second engagement portion (e.g., second engagement flange) 110 extending at a prescribed angle relative to the first engagement portion 108. In the exemplary embodiment, the angle between the first and second engagement portions 108, 110 is approximately 90 degrees, although the angle may be less than 90 degrees or greater than 90 degrees (as discussed above in relation to the angular disposition of the decorative bodies 12, 14) without departing from the spirit and scope of the present disclosure. The first and second engagement portions 108, 110 are positionable adjacent the first and second decorative bodies 12, 14, respectively. In this regard, the configuration of the first and second engagement portions 108, 110 is complementary to the configuration of an inner surfaces of the first and second decorative bodies 12, 14. In the exemplary embodiment, the first and second engagement portions 108, 110 are generally flat to achieve face-to-face engagement with the inner surfaces of the first and second decorative bodies 12, 14.

The outer spacing body 104 includes a first lateral engagement portion 112, a second lateral engagement portion 114, and a middle engagement portion 116. The first lateral engagement portion 112 is positionable adjacent an outer surface of the first decorative body 12 and the second lateral engagement portion 114 is positionable adjacent an outer surface of the second decorative body 14. The middle engagement portion 116 is positioned between the first and second lateral engagement portions 112, 114 and is configured to be engageable to both the first and second decorative bodies 12, 14. In this regard, the middle engagement portion 116 may be sized similar to the desired gap between the first and second decorative bodies 12, 14, as well being similar in size (e.g., width) to that of the outer body of the edge system 10. The middle engagement portion 116 may contact both decorative bodies 12, 14 when the first and second lateral engagement portions 112, 114 are engaged with the first and second decorative bodies 12, 14, respectively.

The shaft 106 extending between the inner setting bracket 102 and the outer spacing body 104 may be part of a screw having a head 118 that is positioned adjacent the inner setting bracket 102. An adjuster 120 is moveable along the shaft 106 to facilitate positional adjustment of the outer setting body 104 relative to the inner setting bracket 102. In this regard, the length of the shaft 106 may be sufficient to extend from the head 118, between the decorative bodies 12, 14, through the middle engagement portion 116, and extend beyond the middle engagement portion 116 to provide sufficient length to interface with the adjuster 120 and allow for movement of the adjuster 120 along the shaft 106.

The adjuster 120 may include a hub 122, a spoke 124, and an outer rim 126, with the spoke 124 extending between the hub 122 and the outer rim 126. The hub 122 is threadingly engageable to the shaft 106, such that rotation of the hub 122 relative to the shaft 106 in a first rotational direction causes translation of the hub 122 along the shaft 106 in a first axial direction, and rotation of the hub 122 relative to the shaft 106 in a second rotational direction causes translation of the hub 122 along the shaft 106 in a second axial direction. The hub 122 may include an internally threaded bore that extends therethrough that is configured to engage with external threads on the shaft 106 to facilitate the selective positioning of the hub 122 relative to the shaft 106.

The adjuster 120 may be tightened against the first and second decorative bodies 12, 14 to hold the first and second decorative bodies 12, 14 in place during installation of the edge system 10. It is contemplated that multiple setting devices 100 may be used to hold multiple decorative bodies 12, 14 in place during installation of the edge system 10. Thus, the setting devices 100 may be individually disengaged and removed from the decorative bodies 12, 14 when the edge system 10 is being installed to create clearance for the edge system 10.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. An edge system for joining a first decorative body with a second decorative body, the edge system comprising:
an inner support body having:
a first support flange positionable adjacent an inner surface of the first decorative body;
a second support flange being positionable adjacent an inner surface of the second decorative body, the second support flange and the first support flange defining an angle therebetween; and
an attachment truss extending between the first support flange and the second support flange;
an outer body having an internal channel formed therein, the outer body being configured to be placeable between the first decorative body and the second decorative body; and
a fastener having a head portion and a shaft portion, the head portion being translatably receivable within the internal channel of the outer body, the shaft portion being sized to extend from the head portion to the inner support body to facilitate connection between the outer body and the inner support body.

2. The edge system recited in claim 1, wherein the first support flange and the second support flange define an angle therebetween equal to 90 degrees.

3. The edge system recited in claim 1, wherein the inner support includes a bore extending therethrough adjacent an intersection of the first support flange and the second support flange.

4. The edge system recited in claim 1, wherein the attachment truss includes an opening, the shaft portion of the fastener being sized to be receivable within the opening in the attachment truss.

5. The edge system recited in claim 1, wherein the outer body includes an exposed plate having a finished outer surface.

6. The edge system recited in claim 5, wherein the outer body further includes a first attachment arm and a second attachment arm, the first attachment arm and the second attachment arm both extending from the exposed plate in spaced relation to each other.

7. The edge system recited in claim 6, wherein the exposed plate, the first attachment arm and the second attachment arm collectively define the internal channel.

8. The edge system recited in claim 7, wherein the first attachment arm and the second attachment arm both include respective distal portions spaced from each other to define a gap therebetween, the gap being sized to allow for passage of the shaft portion therethrough.

9. The edge system recited in claim 1, wherein the inner support body is configured to be selectively moveable along the shaft portion to facilitate application of a compressive force on the first decorative body and the second decorative body between the inner support body and the outer body.

10. An edge system for joining a first decorative body with a second decorative body, the edge system comprising:
an inner support body configured to include a first portion positionable adjacent an inner surface of the first decorative body and a second portion positionable adjacent an inner surface of the second decorative body;
an outer body having an internal channel formed therein, the outer body being configured to be placeable between the first decorative body and the second decorative body; and
a fastener having a head portion and a shaft portion, the head portion being translatably receivable within the internal channel of the outer body, the shaft portion being sized to extend from the head portion to the inner support body to facilitate connection between the outer body and the inner support body.

11. The edge system recited in claim 10, wherein the inner support includes a bore extending therethrough, the bore being sized to facilitate passage of the shaft portion therethrough.

12. The edge system recited in claim 10, wherein the inner support body includes an attachment truss configured to extend between the first decorative body and the second decorative body.

13. The edge system recited in claim 12, wherein the attachment truss includes an opening, the shaft portion of the fastener being sized to be receivable within the opening in the attachment truss.

14. The edge system recited in claim 10, wherein the outer body includes an exposed plate having a finished outer surface.

15. The edge system recited in claim 14, wherein the outer body further includes a first attachment arm and a second attachment arm, the first attachment arm and the second attachment arm both extending from the exposed plate in spaced relation to each other.

16. The edge system recited in claim 15, wherein the exposed plate, the first attachment arm and the second attachment arm collectively define the internal channel.

17. The edge system recited in claim 16, wherein the first attachment arm and the second attachment arm both include respective distal portions spaced from each other to define a gap therebetween, the gap being sized to allow for passage of the shaft portion therethrough.

18. The edge system recited in claim 10, wherein the inner support body is configured to be selectively moveable along the shaft portion to facilitate application of a compressive force on the first decorative body and the second decorative body between the inner support body and the outer body.

19. A setting device for setting a position of a first decorative body relative to a second decorative body, the setting device comprising:
an inner setting bracket having a first engagement portion and a second engagement portion extending at a prescribed angle relative to the first engagement portion, the first and second engagement portions being positionable adjacent the first and second decorative bodies, respectively;
an outer spacing body having a first lateral engagement portion, a second lateral engagement portion, and a middle engagement portion, the first and second lateral engagement portions being positionable adjacent to the first and second decorative bodies, respectively, in spaced relation to the inner setting bracket, the middle engagement portion positioned between the first and second lateral engagement portions and being configured to engageable to both the first and second decorative bodies;
a shaft extending between the inner setting bracket and the outer spacing body; and
an adjuster moveable along the shaft to facilitate positional adjustment of the outer setting body relative to the inner setting bracket.

20. The setting device recited in claim 19, wherein the adjuster includes a hub, a spoke and an outer rim, the spoke extending between the hub and the outer rim, the hub being threadingly engageable to the shaft, such that rotation of the hub relative to the shaft in a first rotational direction causes translation of the hub along the shaft in a first axial direction, and rotation of the hub relative to the shaft in a second rotational direction causes translation of the hub along the shaft in a second axial direction.
